(19) United States
(12) Patent Application Publication
(10) Pub. No.: US 2020/0098052 A1
(43) Pub. Date: Mar. 26, 2020

(54) FLOOD PROTECTION AGREED VALUE PAYOUT AND LINEAR PAY WEBSITE & MOBILE APPLICATION

(71) Applicants: Rawle Oliver King, Fort Washington, MD (US); Oliver Robert Meissner, Washington, DC (US)

(72) Inventors: Rawle Oliver King, Fort Washington, MD (US); Oliver Robert Meissner, Washington, DC (US)

(21) Appl. No.: 16/697,937

(22) Filed: Nov. 27, 2019

Related U.S. Application Data
(63) Continuation of application No. 14/569,723, filed on Dec. 14, 2014, now abandoned.
(60) Provisional application No. 61/963,939, filed on Dec. 19, 2013.

(51) Int. Cl. G06Q 40/08

(52) U.S. Cl. CPC G06Q 40/08; Y02A 10/46; Y02A 10/48

(57) ABSTRACT

A method includes displaying a user interface on a screen of a computing device of a homeowner, and receiving an input of an address for a property of the homeowner. The method also includes receiving global positioning system (GPS) data from the computing device, and verifying the address for the property based on the GPS data. The method also includes calculating probabilities for the property to have a flood event at hypothetical high water heights based on GPS located and mapped floodplain data relating to the property, flood zone map data relating to the property, and historical flood data for a region in which the property is located. The method also includes calculating fixed-value payout amounts based on an estimated elevation of the property, the probabilities for the property to have the flood event at the hypothetical high water heights, and estimated flood water depths in the property.

### CROSS-REFERENCES TO RELATED APPLICATIONS

This application claims priority from provisional Application No. 61/963,939 entitled “Flood Protection Agreed Value Payout and Linear Pay Website & Mobile Application”, filed on Dec. 19, 2013, which is hereby incorporated herein in its entirety.

### BACKGROUND OF THE INVENTION

The present invention relates generally to a customized web and mobile application for buying, selling, distributing, transferring, and/or hosting flood protection agreed value, linear payout flood and other disaster insurance or risk-financing policies and other similar products online. This invention is a portal which enables seamless web integration of agreed value, linear payout and other risk/insurance policies for flood and other disaster related financial products, creating a marketplace for policy sellers, insurance agents and brokers, financial institution, home and business properties owners to easily sell, purchase, transfer, and distribute policies entirely or largely by going to a website, mobile application or combination thereof.

Current flood insurance policy paradigms often require inspectors to thoroughly inspect buildings after a flood in order to estimate damages. In response to Presidential declared disasters, the federal government usually pays huge sums of money in flood disaster assistance to compensate flood victims and find reconstruction and recovery costs. The result is that there is a significant amount of money wasted in the process.

This invention enables homeowners and other property owners, for example, to enroll in plans, which have predetermined payouts in the case of flooding, dependent solely on the depth in structure water depth reached by the flood, largely or entirely online. For the case of the current invention there are limited, if any, requirements for home inspections before and after flooding. Based on Federal Emergency Management Agency (FEMA) and other entity flood high water probability data corresponding to building structure elevation related to Base Flood Elevations (BFE), linear payout amounts are calculated based on water elevation metrics. For example, hypothetical flood depth in structure determinations corresponding to pre-agreed payouts are dependent on flood high water probabilities for certain locations, historic data, high resolution flood zone maps, GPS and other data.

Erlanger US Published Patent No. 2003/6,594,1635 BI describes a data processing system which provides a marketplace for insurance instruments whereby insurers and insurance seekers use the system to exchange insurance instruments, and the provider is able to collect fees which are based on usage statistics which are compiled and calculated using the system.

Brown US Published Patent No. 2013/8,600,104 describes a system utilizing a sensor to acquire spectral images in order to assess the condition of property for insurance purposes. The sensor system has the capability to assess changes in the condition of a property over time and thereby affect insurance related actions.

Feyen US Published Patent No. 2008/7,395,157 describes a system to generate location dependent flood risk assessments for specific territories by incorporating data from distributed gauging stations which measure water depth values, and making probabilistic flood risk determinations thereof.

Celona US Published Patent No. 2013/8,589,189 describes a system which communicates insurance information from a plurality of insurance providers to users through a networked-based system and accompanying GUI, and methodologies for insurance plan recommendations.

Varanasi US Published Patent No. 2013/8,521,567 describes a system for an insurance exchange for providing a neutral, unbiased and automated lead generating platform in a one-stop shop setting, between a set of users and a set of providers, using a unique computer code, and allows users to compare benefits and prices, choose between different insurance products.

Weeks US Published Patent No. 2013/8,515,783 describes a risk assessment method for insurance coverage of an enterprise, which indentifies enterprise risk and numerically scores activities against risk exposure factors, and subsequently binding coverage on the activities in question to risk ratings and associated potential premium rates, and includes automatic aspects such as declining, approving, or renewing coverage based on ratings.

Du US Published Patent No. 2011/7,917,292 describes a flood risk assessment system utilizing geospatial flood risk zoning maps to generate flood frequency versus flood elevation curves to reduce uncertainty in flood risk assessment, and incorporates computerized mathematical models and flood elevation datasets.

### BRIEF SUMMARY OF THE INVENTION

The present embodiments provide a method for a customized web and mobile application (website/app) which can be used by flood hazard or other disaster policy providers (providers), government agencies, and homeowners and other building owners (homeowners), collectively called users, to provide agreed value, linear agreed value or other payout based (payouts) risk insurance policies (policies). The website/app may be produced using computer programming involving HTML, Java, Javascript, PUP or other programming languages involving user interface (UI) design, front end, back end, database and other required functionalities. Global positioning system (GPS) and mapping data and functionality, and on-location visual data would be utilized to compile building elevation, flood risk, and other data for specific addresses.

In one embodiment, the website/app displays payout options for a homeowner to view wherein linear payout amounts are listed corresponding to hypothetical achieved flood water depth in a structure (depth in structure). The payout amounts are calculated based on the estimated elevation of the homeowner's property, the probability of a flood event at various high water heights and resulting depth in structure for the homeowner's property. The website/app optionally displays a number of different policy options, from one or more providers, and the homeowner can choose the policy and payout amount, which is most attractive to him.

### BRIEF DESCRIPTION OF THE DRAWINGS

The above features and advantages of the invention as well as additional features and advantages thereof will be more clearly understood hereinafter as a result of a detailed description of embodiments of the invention when taken in conjunction with the drawings. Like reference numerals refer to corresponding parts throughout the several views of the drawings.

FIG. 1 illustrates a website/app flow chart in accordance with an embodiment of the present invention.

FIG. 2 illustrates an address-specific building with corresponding elevation and depth in structure marks.

FIG. 3 illustrates a plurality of address-specific buildings with respect to a body of water

FIG. 4 illustrates a user interface for the website/app.

FIG. 5 illustrates a wearable eyeglass environment of the present invention wherein a user can select specific determine flood related information for specific addresses,

FIG. 6 illustrates a computing database and user delivery environment for the present invention.

### DETAILED DESCRIPTION OF THE INVENTION

To better understand the various embodiments of this invention, a discussion relating directly to the drawings follows.

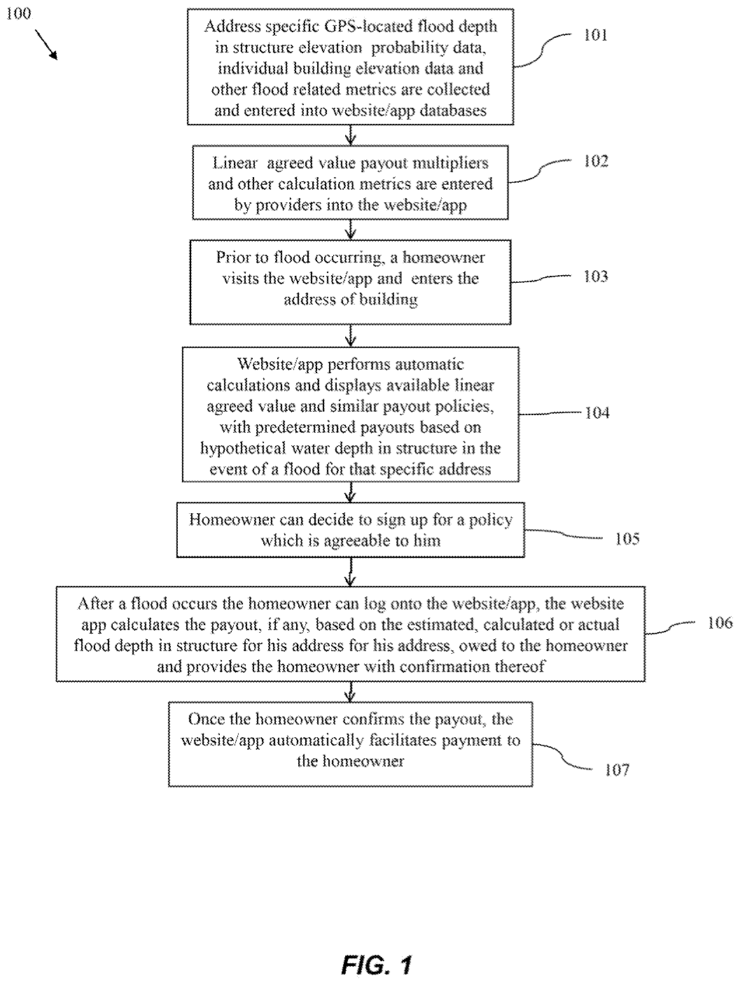

FIG. 1 depicts a website/app flow chart in accordance with an embodiment of the present invention. Address specific GPS-located flood depth in structure elevation probability data, individual building elevation data and other flood related metrics are collected and entered into website/app databases 101. Then, flood protection agreed value linear payout multipliers and other calculation metrics are entered by providers into the website/app 102. Prior to flood occurring, a homeowner visits the website/app and enters the address of building 103. Website/app performs automatic calculations and displays available flood protection agreed value and similar payout policies, with predetermined payouts based on hypothetical water depth in structure in the event of a flood for that specific address 104. Homeowner can decide to sign up for a policy which is agreeable to him 105. After a flood event occurs the homeowner can log onto the website/app, the website app calculates the payout, if any, based on the estimated, calculated or actual flood depth in structure for his address for his address, owed to the homeowner and provides the homeowner with confirmation thereof 106. Once the homeowner confirms the payout, the website/app automatically facilitates payment to the homeowner 107.

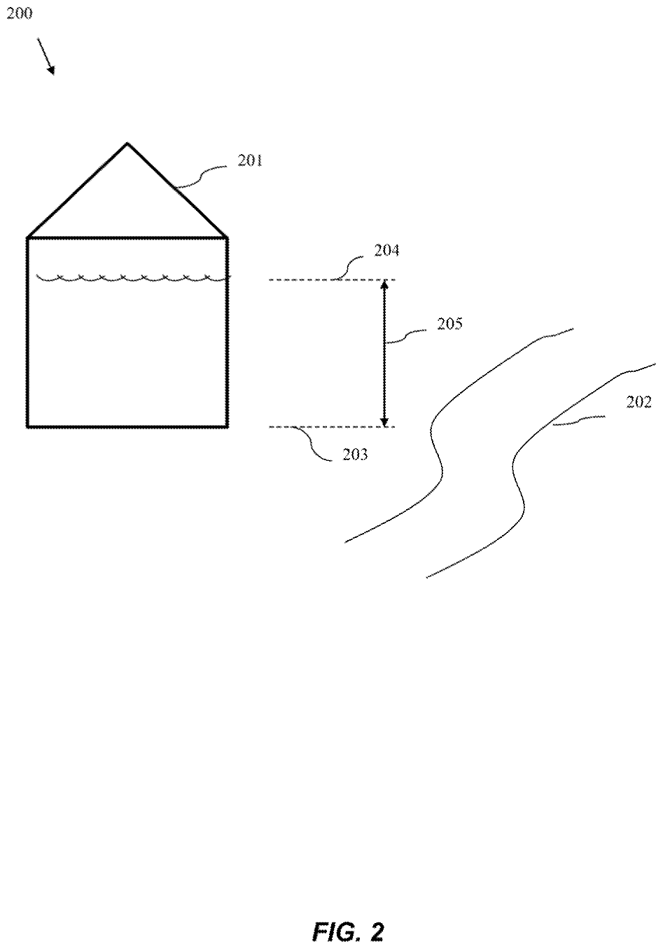

FIG. 2 depicts an address specific building 201 with flood risk from a body of water such as a river 202 or other source of high flood water. The building elevation 203 is recorded and entered into a database for the website/app. Probability for varying depth in structure 204 in the event of flooding, compared to the differential 205 with respect to the building elevation 203, are estimated and entered in to the database for the website/app prior to a flood event, and corresponding payouts are generated by the website/app for each depth in structure scenario. After a flood event the actual depth in structure 204 is entered into the website/app and confirmations of the actual payout owed to the homeowner/policy holder are calculated.

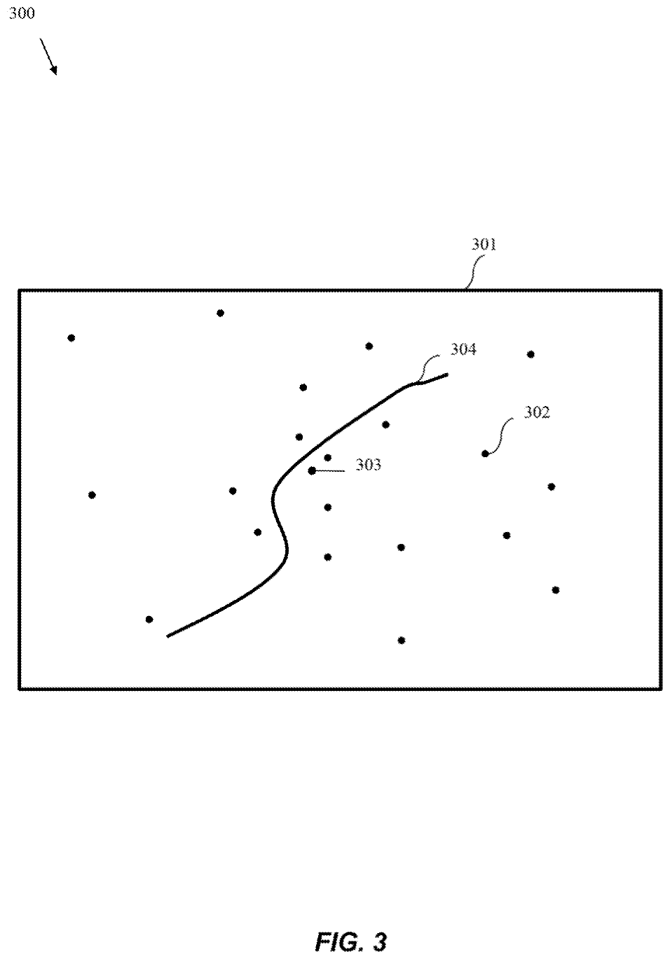

FIG. 3 depicts a user interface 301 of the website/app wherein are located a plurality of representations of address-specific buildings 302, 303 near a body of water, which could be a river, lake, stream, ocean or any other body of water. Users can select on specific address for a building and receive corresponding flood event related data.

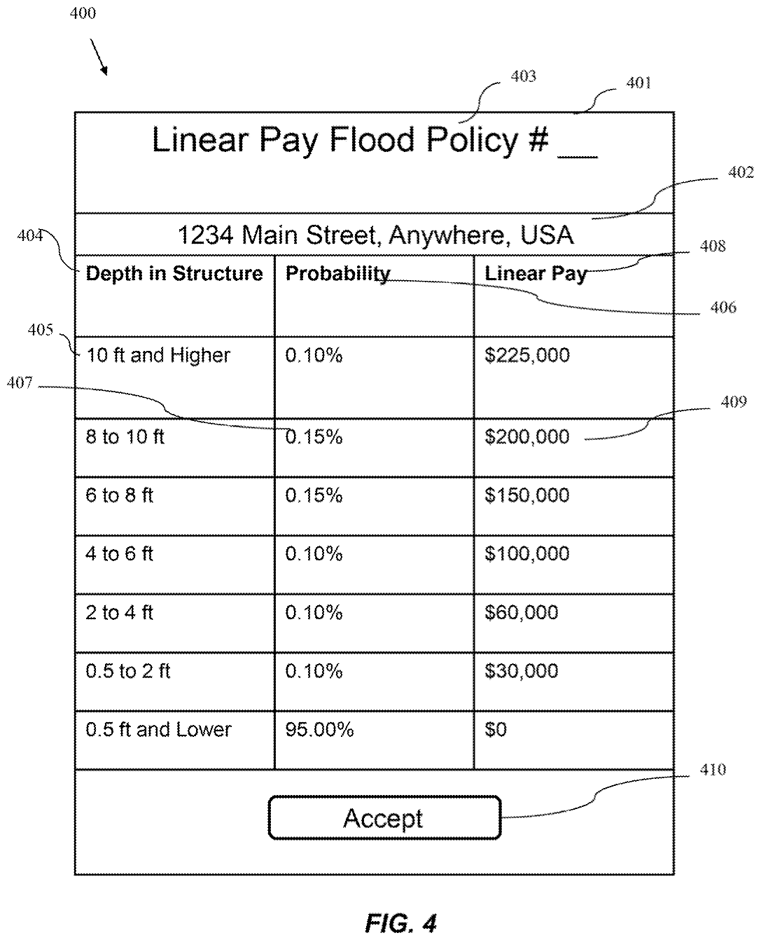

FIG. 4 depicts an example user interface page 401 of the website/app. The address for the building in question is entered in the address field 402, or automatically entered into the field based on account preferences, and a corresponding proposed policy offering 403 is displayed. The details of the policy are depicted outlining varying, hypothetical depth in structure amounts 404, 405, corresponding probability of that depth in structure occurring 406, 407, and the corresponding agreed value linear payout for each depth in structure flooding occurrence 408, 409. The user can review the policy and if it is satisfactory, can select the accept button 410 and continue to finalize purchase of the policy.

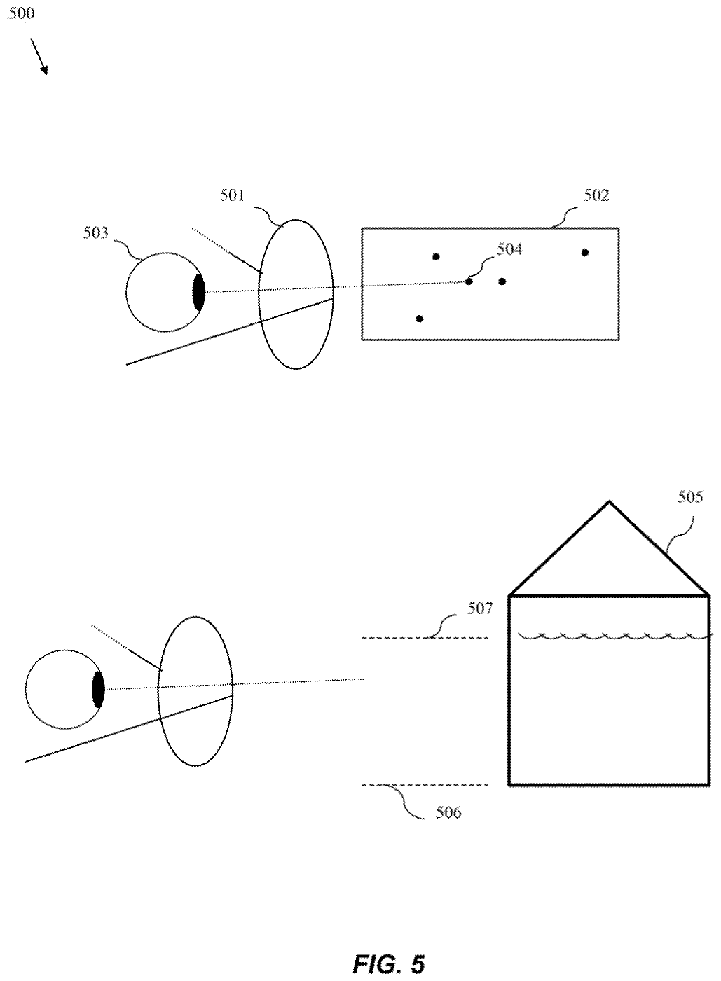

FIG. 5 depicts an environment wherein website/app data are viewed on a visual based computerized platform, such as Google Glass 501, on which the user can see the user interface 502 as an image in front of the user's eyes 503 as a projection, hologram or displayed via other optical technique. In addition to using a mouse, tooltip, hover or other type of offering selection method, the user can look at a representation of an specific address-specific building 504 on the user interface and use an eye-based selection method, such as blinking, staring, and thereby automatically selecting the offering or displaying an informational and/or actionable tooltip or popup regarding the offering. The visual based computerized platform can also be used to look at buildings 505 when, for example, walking or driving at specific locations, and receive information on the building elevation 506, hypothetical or actual depth in structure 507, for purposes including survey and analysis both prior to and after flood occurrence.

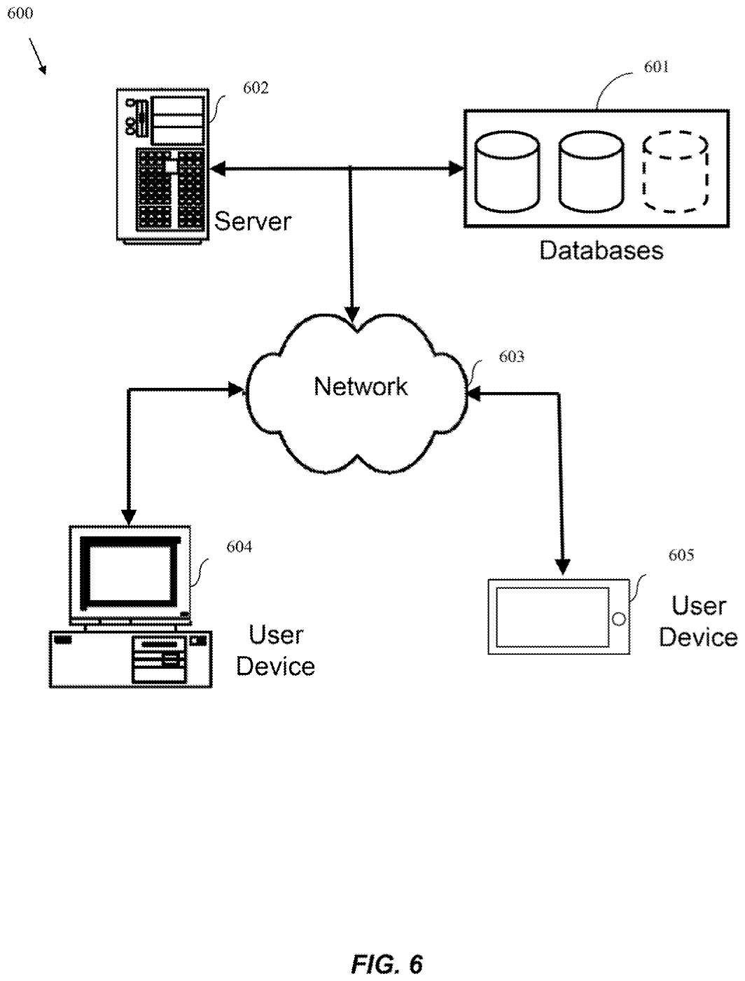

FIG. 6 depicts an example computing environment for the current invention. All flood related data for specific addresses and locations of a main database 601 of a provider are entered and stored on a server 602 operated by the provider. The databases are regularly updated and referenced programmatically either locally, or over a network 603, through computer programming code such as PUP language or other database programming languages. The main website/app front end which homeowners and other users see are accessed by the user over the network via internet signal on user devices such as a desktop computer 604, mobile device 605, or on other computerized devices.

In one embodiment, a homeowner visits the website/app and signs up for an account and inputs the address of the property the homeowner would like to view policies for, or alternatively, the homeowner can just visit the website/app without an account and enter only the address for the building he would like to view policies for. Based on the inputted address, and prior to a flood, the website/app, after querying its database, and based on the structure elevation of the building represented by the inputted address compared to its government base flood elevation, returns to the homeowner one or more payout policies for their review. In addition to automatically calculating flood protection agreed value linear payouts, other factors such as deductibles, can be included in the calculations and in the policy details. If the homeowner has not yet signed up for an account with the website/app he is required to do so in order to proceed with the purchase of a policy. Once the homeowner is signed into his account, he then has the option to select one of the payout policies and proceed with payment arrangements on the website/app.

In one embodiment, the website/app is applicable to any areas which have a chance of flooding, whether from high waters from rivers, streams, flash floods, tsunami's, rainfall, tornadoes, hurricanes, typhoons, tropical storms, coastal areas, dam breakages and other sources of high water. In all cases the building elevation for specific addresses are compared with probabilities of the occurrence of depth in structure water levels due to flooding, and flood protection agreed value payouts are formulated.

In one embodiment, after a flood occurs, and assuming a homeowner has signed up for an account and signed up for a policy website/app prior to the flood, the homeowner can log on to the homeowner's account on the website/app. Based on the address for the homeowner, the website/app, after querying its database, and based on the structure elevation of the building represented by the inputted address compared to its corresponding location-specific government. Base Flood Elevation (BFE), which is the elevation of a hypothetical flood having a one percent chance of being equated or exceeded in any given year, returns to the homeowner the payout which is owed to the homeowner based on the previously agreed-upon arrangement. The homeowner has the option to confirm and accept the payout presented on the website/app, and if acceptable, can select an option to confirm the payout amount. At that point the website/app automatically processes the required payout and the payout is processed and ultimately sent to the homeowner.

In one embodiment, prior to a flood, the website/app incorporates one or more databases of buildings, matched to specific addresses, respective building elevations based on Federal Emergency Management Agency (FEMA) or other government entity BFE, payout schedules which take into consideration flood occurrence and high water levels.

In one embodiment, data required to calculate payouts for specific building addresses are garnered from databases of Federal and local government agencies, nonprofits or other entities. Examples of such data include flood probability data, GPS located and mapped floodplain, high water mark probability and other flood related data, elevations of buildings at specific addresses mapped to GPS coordinates and other data. Such data may be sourced by entities incorporating GPS geo-location, government digital floodmap data, GPS based mapping systems, aerial surveillance, LIDAR sensing, other sourcing methods, or some combination thereof.

In one embodiment, in the event of a flood, the flood high water marks for various locations in the flood zone are automatically or manually entered into a database for the website/app. Flood high water mark data, from FEMA or other government authorities, and which is mapped to specific locations and addresses, is added to the database of the website/app by government authorities, or providers under government authority, and calculations are automatically made to determine payouts which are owed to homeowners who have signed up for policies.

In one embodiment, the website/app is accessible via a wearable computerized device such as Google Glass or another visual based computerized device, on which the user can see the website/app displayed as an image in front of the user's eyes as a projection, hologram or displayed via other optical technique. In addition to using a mouse, tooltip, hover or other type of offering selection method, the user can look at a specific offering on the GUI and use an eye-based selection method, such as blinking, staring, and thereby automatically selecting the offering or displaying an informational and/or actionable tooltip or popup regarding the offering. Providers, building owners and others can automatically receive flood related information pertaining to a specific building by either navigating on the screen of the wearable device, or by, for example, looking at a property to determine its flood related metrics such as structure elevation compared to base flood elevations and other metrics.

The invention has now been described in detail for purposes of clarity and understanding. However, it will be appreciated that certain changes and modifications may be practiced within the scope of the appended claims. Accordingly, it should be recognized that many other systems, functions, methods, and combinations thereof are possible in accordance with the present invention. Thus, although the invention is described with reference to specific embodiments and figures thereof, the embodiments and figures are merely illustrative, and not limiting of the invention. Rather, the scope of the invention is to be determined solely by the appended claims.

What is claimed is:

1. A method, comprising:
displaying a user interface on a screen of a computing device of a homeowner;
receiving, through the user interface, an input of an address for a property of the homeowner;
receiving, by a processor, global positioning system (GPS) data from the computing device of the homeowner;
verifying, by the processor, the address for the property based on the GPS data;
calculating, by the processor, for the property at the address, a plurality of probabilities for the property to have a flood event at a plurality of hypothetical high water heights based on GPS located and mapped floodplain data relating to the property, flood zone map data relating to the property, and historical flood data for a region in which the property is located;
calculating, by the processor, a plurality of fixed-value payout amounts based on an estimated elevation of the property, the plurality of probabilities for the property to have the flood event at the plurality of hypothetical high water heights, and estimated flood water depths in the property;
transmitting, through a network to the computing device of the homeowner, the plurality of fixed-value payout amounts, the plurality of probabilities for the property to have the flood event, and the estimated flood water depths in the property;
displaying, through the user interface, a proposed relationship between the plurality of fixed-value payout amounts for the property that the homeowner will receive if the flood event occurs, the plurality of probabilities for the property to have the flood event, and the estimated flood water depths in the property; and
receiving, by the processor from the computing device, an input from the homeowner to accept the proposed relationship.

2. The method of claim 1, further comprising:
receiving, through the user interface, a log-in input from the homeowner, after the flood event occurs;
receiving, through the user interface, an input of an actual flood water depth in the property of the homeowner;
determining a fixed-value payout amount from the plurality of fixed-value payout amounts for the property of the homeowner based on the actual flood water depth in the property; and
displaying, through the user interface, the determined fixed-value payout amount to the homeowner.

3. The method of claim 2, further comprising:
receiving a confirmation input indicating acceptance by the homeowner of the determined fixed-value payout amount; and
facilitating payment to the homeowner the determined fixed-value payout amount.

4. The method of claim 1, further comprising:
receiving, through the user interface, a log-in input from the homeowner, after the flood event occurs;
determining a fixed-value payout amount from the plurality of fixed-value payout amounts for the property of the homeowner based on an estimated flood water depth in the property; and
presenting, through the user interface, the determined fixed-value payout amount to the homeowner.

5. The method of claim 4, further comprising:
receiving a confirmation input indicating acceptance by the homeowner of the determined fixed-value payout amount; and
facilitating payment to the homeowner the determined fixed-value payout amount.

6. The method of claim 1, wherein the user interface is a user interface of a website or a user interface of a mobile application.

7. The method of claim 1, further comprising collecting and storing probability data relating to address specific GPS-located flood depth with respect to structure elevation, and individual building elevation data.

8. The method of claim 1, further comprising:
displaying, in the user interface, a graphic representation of a plurality of address-specific properties near a body of water; and
receiving, through the user interface, an input indicating a selection of a specific address for a property; and
displaying, in the user interface, flood event related data.

9. A system, comprising:
a computer server;
a network,
wherein the computer server is connected to a computing device of a homeowner through the network, and configured to:
display a user interface on a screen of the computing device of the homeowner;
receive, through the user interface, an input of an address for a property of the homeowner;
receive, by the computer server, global positioning system (GPS) data from the computing device of the homeowner;
verify, by the computer server, the address for the property based on the GPS data;
calculate, by the computer server, for the property at the address, a plurality of probabilities for the property to have a flood event at a plurality of hypothetical high water heights based on GPS located and mapped floodplain data relating to the property, flood zone map data relating to the property, and historical flood data for a region in which the property is located;
calculate, by the computer server, a plurality of fixed-value payout amounts based on an estimated elevation of the property, the plurality of probabilities for the property to have the flood event at the plurality of hypothetical high water heights, and estimated flood water depths in the property;
transmit, through the network to the computing device of the homeowner, the plurality of fixed-value payout amounts, the plurality of probabilities for the property to have the flood event, and the estimated flood water depths in the property;
display, through the user interface, a proposed relationship between the plurality of fixed-value payout amounts for the property that the homeowner will receive if the flood event occurs, the plurality of probabilities for the property to have the flood event, and the estimated flood water depths in the property; and
receive, by the computer server from the computing device, an input from the homeowner to accept the proposed relationship.

10. The system of claim 9, wherein the computer server is also configured to:
receive, through the user interface, a log-in input from the homeowner, after the flood event occurs;
receive, through the user interface, an input of an actual flood water depth in the property of the homeowner;
determine a fixed-value payout amount from the plurality of fixed-value payout amounts for the property of the homeowner based on the actual flood water depth in the property; and
present, through the user interface, the determined fixed-value payout amount to the homeowner.

11. The system of claim 10, wherein the computer server is also configured to:
receive, through the user interface, a confirmation input indicating acceptance by the homeowner of the determined fixed-value payout amount; and
facilitate payment to the homeowner the determined fixed-value payout amount.

12. The system of claim 9, wherein the computer server is also configured to:
receive, through the user interface, a log-in input from the homeowner, after the flood event occurs;
determine a fixed-value payout amount from the plurality of fixed-value payout amounts for the property of the homeowner based on an estimated flood water depth in the property; and
display, through the user interface, the determined fixed-value payout amount to the homeowner.

13. The system of claim 12, wherein the computer server is also configured to:
receive, through the user interface, a confirmation input indicating acceptance by the homeowner of the determined fixed-value payout amount; and
facilitate payment to the homeowner the determined fixed-value payout amount.

14. The system of claim 9, wherein the user interface is a user interface of a website or a user interface of a mobile application.

15. The system of claim 9, wherein the computer server is also configured to:
collect and store probability data relating to address specific GPS-located flood depth with respect to structure elevation, and individual building elevation data.

16. The system of claim 9, wherein the computer server is also configured to:
display, in the user interface, a graphic representation of a plurality of address-specific properties near a body of water; and
receive, through the user interface, an input indicating a selection of a specific address for a property; and
display, in the user interface, flood event related data.

17. A method, comprising:
displaying a user interface on a screen of a wearable computing device;
displaying, in the user interface, a plurality of representations of a plurality of buildings;
receiving, through the user interface, an eye-based selection input selecting a representation of a building from the plurality of representations;
determining, using the wearable computing device, a location of the building represented by the selected representation, based on map data and Global Positioning System (GPS) data relating to the building;
calculating, using the wearable computing device, flood related metrics relating to the building, the flood related metrics comprising a structure elevation of the building compared to base flood elevations, and a hypothetical estimated flood water depth in the building; and
displaying, in the user interface, an image representing the building along with the calculated flood related metrics.

18. The method of claim 17, further comprising:
calculating, by the wearable computing device, a probability for the building to have a flood even at the hypothetical high water height based on the GPS data and mapped floodplain data relating to the building, flood zone map data relating to the building, and historical flood data for a region in which the building is located; and
calculating, by the wearable computing device, a fixed-value payout amount that a homeowner will receive if the flood event occurs, based on the structure elevation of the building, the hypothetical estimated flood water depth in the building, and the probability for the building to have the flood event at the hypothetical estimated flood water depth in the building.

19. The method of claim 18, further comprising:
displaying, in the user interface of the wearable computing device, the fixed-value payout amount that the homeowner will receive.

20. The method of claim 19, further comprising:
receiving, through the user interface, an eye-based input indicating an agreement by the homeowner to the fixed-value payout amount.
